(19) United States
(12) Patent Application Publication
(10) Pub. No.: US 2026/0274141 A1
(43) Pub. Date: Sep. 17, 2026

(54) PACKAGE HANDLING SYSTEM AND METHODS OF USE

(71) Applicant: Mathew L. Grell, Norcross, GA (US)

(72) Inventor: Mathew L. Grell, Norcross, GA (US)

(21) Appl. No.: 19/675,201

(22) Filed: May 12, 2026

Related U.S. Application Data
(63) Continuation-in-part of application No. 19/324,584, filed on Sep. 10, 2025.
Application No. 19/324,584 is a continuation of application No. 18/308,744, filed on Apr. 28, 2023, now Pat. No. 12,427,903.
(60) Provisional application No. 63/363,856, filed on Apr. 29, 2022.

(51) Int. Cl. B60P 1/00; B60P 3/00; B64U 20/00; B64U 101/64

(52) U.S. Cl. CPC B60P 1/00; B60P 3/00; B64U 20/00; B64U 2101/64

(57) ABSTRACT

A package handling system for automated last-mile delivery with a delivery truck having a rear cargo area, a storage bin positioned within the cargo area containing a plurality of sequenced delivery packages, and a robotic arm mounted inside the cargo area. The robotic arm is configured to pick a delivery package from the storage bin and transfer it directly to an autonomous ground rover positioned adjacent the truck, to a hinged drone platform pivotally mounted on the truck's rear tailgate, or to a hovering drone via a contactless end-effector handoff. The system eliminates the need for a drone to enter the enclosed truck interior and enables rapid, fully automated handover of pre-sequenced packages from the truck to either a rover or drone for final delivery to a customer doorstep or designated location, thus, significantly reducing labor, delivery time, and cost in e-commerce fulfillment operations.

### CROSS REFERENCE TO RELATED APPLICATIONS

To the full extent permitted by law, the present United States Non-Provisional Patent Application is a Continuation in Part of and hereby claims priority to and the full benefit of, U.S. application Ser. No. 19/324,584, filed on Sep. 10, 2025, entitled “PACKAGE HANDLING SYSTEM AND METHODS OF USE”, which is a Continuation of U.S. Pat. No. 12,427,903 issued on Sep. 30, 2025, entitled “PACKAGE HANDLING SYSTEM AND METHODS OF USE”, which claims the benefit of U.S. Application No. 63/363,856, filed on Apr. 29, 2022, entitled “PACKAGE HANDLING SYSTEM AND METHODS OF USE”. The foregoing is incorporated herein by reference in its entirety.

### FIELD OF THE DISCLOSURE

The present disclosure is directed at the delivery of packages. More specifically, the present disclosure is directed to a system to bundle packages at warehouse, deliver by truck to curb, and drone or rover to porch.

### BACKGROUND

Logistics and e-commerce era package delivery entails regional warehouses of products in storage ready for purchase and quick delivery to customer designated address. More specifically, these warehouses are massive and highly organized facilities that house millions of products across hundreds of categories. These products are managed and processed by proprietary software, which allows for rapid fulfillment and delivery of orders. Once a customer places an order, the warehouse staff quickly locates the relevant product and prepares it for shipment. These businesses rely on an extensive logistics network for its delivery operations, including trucking, delivery vehicles and last-mile delivery services. This allows logistics and e-commerce businesses to offer a wide range of shipping speeds, from same-day delivery to standard shipping times of just a few days. Overall, these warehouse and delivery operations are incredibly efficient and well-run.

One disadvantage with conventional warehouse systems is packages are not linked together in order of delivery from first delivery to last delivery for a given vehicle route requiring drivers to select delivery packages at each stop.

Another disadvantage with conventional delivery is if drones are utilized the drone must enter the enclosed vehicle, identify the package to be delivered, pick the package up, and maneuver out of the enclosed vehicle to deliver the package.

Therefore, it is readily apparent that there is a recognizable unmet need for a package handling system and methods of use that may be configured to address at least some aspects of the problems discussed above.

### SUMMARY

Briefly described, in an example embodiment, the present disclosure may overcome the above-mentioned disadvantages and may meet the recognized need for package handling system and methods of use may include a truck and drone delivery system having one or more drones, a delivery truck, the delivery truck having one or more drone platforms. The delivery truck may include one or more catch bins or containers to catch undeliverable packages and/or used battery packs. The drone platforms may include at least a pair of spaced apart landing pads for the one or more drones. The truck or bins may house and transport at least one set of delivery packages affixed in series to a feed tape according to a sequence in a delivery route (delivery package feed tape mechanism and tape cutter). The feed tape may be fed into a feed tape mechanism and tape cutter. A microprocessor or controller controls feed tape mechanism (such as with drive wheels) and tape cutter may be engaged based on the position in a route (GPS) via a reader reading a code, such as a bar code on the feed tape or delivery package and confirms package delivery and GPS location or position. Drone lands on drone pad. Processor or controller detects drone is in positions on drone platform. The feed tape mechanism gripping(s) the feed tape and propels the feed tape and delivery package (n) to the drone platform and preferably between the pair of spaced apart landing pads. Drone with tape capture mechanism receives feed tape and delivery package (n) in its drone tape capture mechanism. Drone communicates to Processor or controller that feed tape and delivery package (n) is secure in drone tape capture mechanism. Processor or controller initiates tape cutter to cut feed tape segment of delivery package (n) from remaining feed tape. Drone lifts off drone pad and delivers feed tape segment and delivery package (n) to addressed delivery location (n), such as front door, garage (drone trigger garage to open & close), porch, drop box, or other designated location. Drone returns to drone platform to pick up feed tape and delivery package (n+1). Delivery truck moves to address (n+1). Repeat.

Alternate embodiment drone platform and delivery package feed tape mechanism and tape cutter may be positioned in an interior of the delivery truck.

Alternate embodiment drone platform and delivery package feed tape mechanism and tape cutter may be positioned on a container or bin and may be on a pallet that a fork truck moves into an interior or platform of the delivery truck.

Accordingly, in another aspect, the present disclosure may include a battery pack replacement system. The battery pack replacement system may include one or more drones, a delivery truck, the delivery truck having one or more drone platforms. The delivery truck may include one or more catch bins or containers to catch used batteries. The truck or bins may house at least one set of drone replacement batteries (battery pack) affixed in series to a feed tape. The feed tape may be fed into a drone battery feed tape mechanism and tape cutter. A microprocessor or controller controls drone battery feed tape mechanism and tape cutter based on drone power levels. Drone lands on drone pad. Processor or controller detects drone is in positions on drone platform and drone is low on power. The drone battery feed tape mechanism and tape cutter gripping(s) the feed tape and propels the feed tape and drone battery (n) to the drone platform. Drone with battery tape capture mechanism receives feed tape and drone battery (n) in its drone battery tape capture mechanism. Drone communicates to Processor or controller that feed tape and drone battery (n) is secure in drone battery tape capture mechanism. Drone may be powered via drone platform contact leads during drone battery swap out time period. Old or spent drone battery (n-1) is pushed from drone battery receiver by drone battery tape capture mechanism and drops or is captured in catch bin to catch discarded drone batteries and new battery (n) is inserted into drone battery receiver.

Accordingly, in another aspect, the present disclosure may include feed tape and delivery package fill system. Feed tape and delivery package fill system may be utilized to fill and seal the packages and affix to a feed tape or fill and seal the packages affixed in series to a feed tape according to delivery route using a delivery package feed tape mechanism to position each package in a loading terminal to enable the drone or robot to place or drop purchased item(s) into a package according to a delivery route. Then print and affix labels and codes such as bar codes to the package. These functions may occur in a warehouse or factory.

In an exemplary embodiment of a package handling system for delivery of a widget ordered and destined for a delivery stop on a delivery route, having one or more delivery packages affixed in series to a package feed tape, a feed tape mechanism, the feed tape mechanism configured to engage the package feed tape to propel the package feed tape and the one or more delivery packages affixed thereto, a tape cutter to cut the package feed tape to separate at least one delivery package from the one or more delivery packages, a drone platform positioned proximate the tape cutter, and a drone having a drone feed tape capture system to receive the package feed tape and the at least one delivery package of the one or more delivery packages affixed to the package feed tape.

In a second exemplary embodiment of an a battery handling system, having one or more batteries affixed in series to a battery feed tape, a battery feed tape mechanism, the battery feed tape mechanism configured to engage the battery feed tape to propel the battery feed tape and the one or more batteries affixed thereto, a tape cutter to cut the battery feed tape to separate at least one battery from the one or more batteries, a drone platform positioned proximate the tape cutter, and a drone having a drone feed tape capture system to receive the battery feed tape and the at least one battery from the one or more batteries affixed to the battery feed tape.

In a third exemplary embodiment of an envelope filling system, having one or more envelopes affixed in series to a feed tape, the feed tape having a series of feed apertures, a feed tape mechanism, the feed tape mechanism configured to engage the series of feed apertures of the feed tape to propel the feed tape and the one or more envelopes affixed thereto, a tape cutter to cut feed tape to separate one or more envelopes from the one or more envelopes, a robotic arm positioned proximate the feed tape mechanism, and at least one collection of widgets positioned proximate the robotic arm wherein the robotic arm picks a designated widget associated with a delivery address in a sequence of a delivery route and places the designated widget in an envelope from the one or more envelopes to form a delivery package in a sequence of delivery packages.

It is an object of the disclosure herein to enable drone pickup and delivery of one or more packages destined for an address from multiple packages affixed in series to a feed tape.

It is an object of the disclosure herein to reduce manpower cost in a warehouse and delivery personnel to deliver packages.

It is an object of the disclosure herein to enable swap out spent drone battery/batteries with a new battery/batteries from multiple drone batteries affixed in series to a feed tape automatically while on the drone platform.

A feature of the present disclosure includes the advantage of using truck and drone delivery system drones to deliver package. Drones can significantly reduce delivery times, as they can travel directly to the customer's doorstep from the truck rather than relying on high cost human ground transportation methods. This means that customers can receive their packages much faster and at lower costs, which can be especially beneficial for time-sensitive deliveries.

A feature of the present disclosure includes the advantage of using battery pack replacement system enables field replacement of drone battery systems significantly reduce delivery times by keeping drones in operation verses stopping to charge drone battery systems.

A feature of the present disclosure includes the advantage of using feed tape and delivery package fill system where packages are affixed to a tape feed in sequence matching delivery stops along a delivery route. Packages affixed to a tape feed in sequence matching delivery stops along a delivery route can significantly reduce delivery times and reduce incorrect deliveries. This means that customers can receive their packages much faster and more accurately, which can be especially beneficial for time-sensitive deliveries.

A feature of the present disclosure includes using drones for delivery of packages can also help to lower delivery costs. Traditional delivery methods often require multiple personnel and vehicles to make a single delivery, which can be costly and time-consuming. Drones, robots, and self-driving vehicles on the other hand, have low overhead operating costs and can make deliveries more efficiently and quickly.

A feature of the present disclosure includes packages affixed in series to a feed tape according to delivery route.

A feature of the present disclosure includes a delivery package feed tape mechanism and tape cutter.

A feature of the present disclosure includes a drone platform with spaced landing pads.

A feature of the present disclosure includes a drone, drone platform, and drone with package tape capture mechanism.

A feature of the present disclosure includes drone battery pack(s) affixed in series to a battery feed tape.

A feature of the present disclosure includes drone battery feed tape mechanism and tape cutter.

A feature of the present disclosure includes a catch bin to catch discarded drone batteries or undeliverable packages.

A feature of the present disclosure includes a rover to deliver the package to a doorstep or garage door area from the vehicle.

A feature of the present disclosure includes a robotic arm, shelves, and bin in the truck to pick delivery package(s) from.

A feature of the present disclosure includes a conveyor system, package push system to conveyor in the truck to place the package outside the truck.

These and other features of package handling system and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure for package handling system and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1 is a perspective cutout view of a delivery truck transporting one or more packages, destined for an address as delivery package (Pn) and addresses for delivery package (Pn+1, Pn+2 . . . ), from multiple packages affixed in series to a feed tape, a feed tape mechanism and cutter, a drone platform, a catch bin, according to select embodiments of the instant disclosure;

FIG. 1A is a perspective view of a delivery vehicle with a robotic arm to pick packages in the vehicle and place them outside the vehicle on a rover, according to select embodiments of the instant disclosure;

FIG. 1B is a perspective view of a delivery vehicle with a robotic arm to pick packages from a bin in the vehicle and place them outside the vehicle on a rover, according to select embodiments of the instant disclosure;

FIG. 1C is a perspective view of a delivery vehicle with a robotic arm to pick packages in the vehicle and place them outside the vehicle through an aperture in floor or sidewall of vehicle onto a rover, according to select embodiments of the instant disclosure;

FIG. 1D is a perspective view of a delivery vehicle with a conveyor system to deliver packages in the vehicle to a rover outside the vehicle, according to select embodiments of the instant disclosure;

FIG. 1E is a perspective view of a delivery vehicle with a robotic arm system to deliver packages in the vehicle to a drone platform positioned inside or outside the vehicle, according to select embodiments of the instant disclosure;

FIG. 1F is a perspective view of a delivery vehicle with a drone platform where the drone is picking the package from the drone platform, according to select embodiments of the instant disclosure;

FIG. 1G is a perspective view of a delivery vehicle with a robotic arm system hands off packages directly to drone, according to select embodiments of the instant disclosure;

FIG. 2 is a perspective view of feed tape mechanism for one or more packages and tape cutter shown with feed tape fed into feed tape mechanism holding in series delivery package (Pn) and delivery package (Pn+1, Pn+2 . . . ), tape cutter, and a drone platform, according to select embodiments of the instant disclosure;

FIG. 3 is a perspective view of feed tape mechanism for one or more packages and tape cutter shown with feed tape fed into feed tape mechanism holding in series delivery package (Pn) and delivery package (Pn+1, Pn+2 . . . ), tape cutter, and a drone platform, according to select embodiments of the instant disclosure, shown in a container on a palate;

FIG. 4A is a perspective view of the drone in flight around drone platform of FIGS. 1-3, according to select embodiments of the instant disclosure;

FIG. 4B is a side view of drone in flight carrying package in route to a delivery address transporting a package from the drone platform, according to select embodiments of the instant disclosure;

FIG. 4C is a perspective view of rover carrying a package in route to a delivery address, according to select embodiments of the instant disclosure;

FIG. 4D is a perspective view of rover having a dump container hingedly attached to the platform, according to select embodiments of the instant disclosure;

FIG. 4E is a perspective view of rover having a forklift mechanism attached to the structure, according to select embodiments of the instant disclosure;

FIG. 4F is a perspective view of rover having a pair of hooks attached to the structure, according to select embodiments of the instant disclosure;

FIG. 5 is a perspective cutout view of a delivery truck transporting one or more batteries, battery (Bn) and batteries (Bn+1, Bn+2 . . . ) to power drone(s) affixed in series to a feed tape, a feed tape mechanism and cutter, drone battery feed tape capture system, a drone platform, a catch bin, according to select embodiments of the instant disclosure;

FIG. 5A is a perspective view of feed tape mechanism for one or more batteries and tape cutter shown with feed tape fed into feed tape mechanism holding in series one or more batteries, battery (Bn) and batteries (Bn+1, Bn+2 . . . ) to power drone(s), tape cutter, and a drone platform, according to select embodiments of the instant disclosure;

FIG. 5B is a side view of drone in flight carrying with fresh set of batteries, according to select embodiments of the instant disclosure;

FIG. 6 is an exploded view of feed tape mechanism and tape cutter shown with feed tape fed into feed tape mechanism holding in series delivery envelopes (En), and tape cutter, robot, or robotic arm to stuff envelope En and envelopes (En+1, En+2 . . . ) with customer purchased content, such as collection of widgets Wn and widgets (Wn+1, Wn+2 . . . ) to make delivery package (Pn) and delivery packages (Pn+1, Pn+2 . . . ) for delivery to designated addresses in a route, according to select embodiments of the instant disclosure;

FIG. 7 is a map of a delivery route having a series of delivery stops associated with designated delivery packages for each stop or address in a sequence of a delivery route; and

FIG. 8 is a flowchart.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures, specific terminology is employed for clarity. The present disclosure, however, is not intended to be limited to the specific terminology selected; it is to be understood that each specific element includes all technical equivalents that operate in a similar manner to accomplish similar functions. Embodiments of the claims may, however, be embodied in many different forms and should not be construed as limited to the embodiments set forth herein. The examples set forth herein are non-limiting examples, and are merely examples among other possible examples. It is recognized herein that the optimum dimensional relationships, to include variations in size, materials, shape, form, position, connection, function and manner of operation, assembly and use, are intended to be encompassed by the present disclosure.

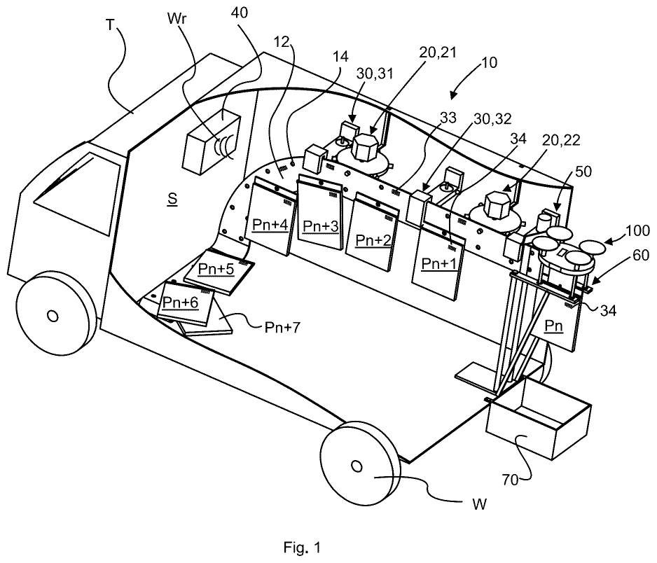

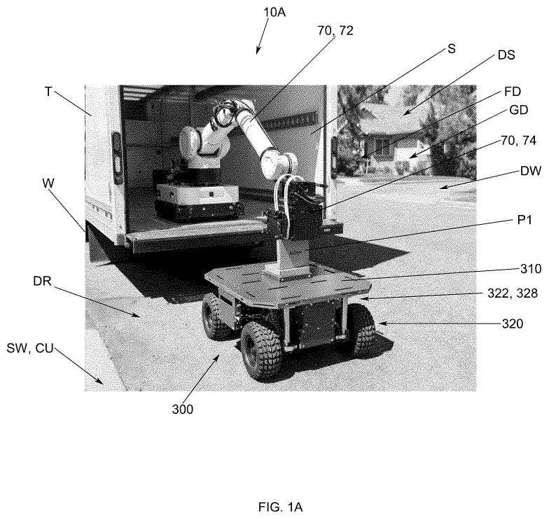

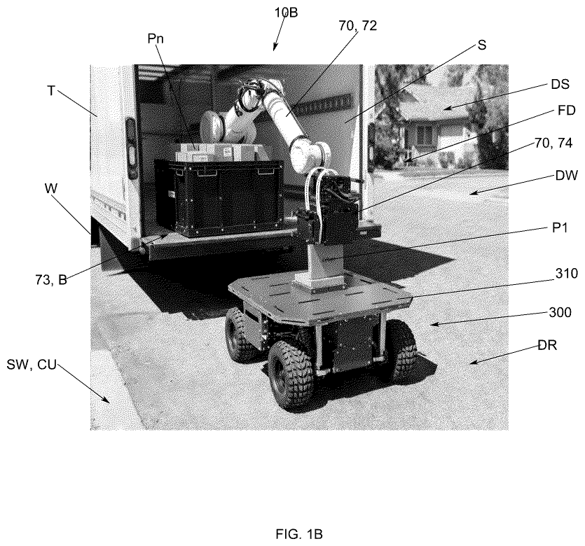

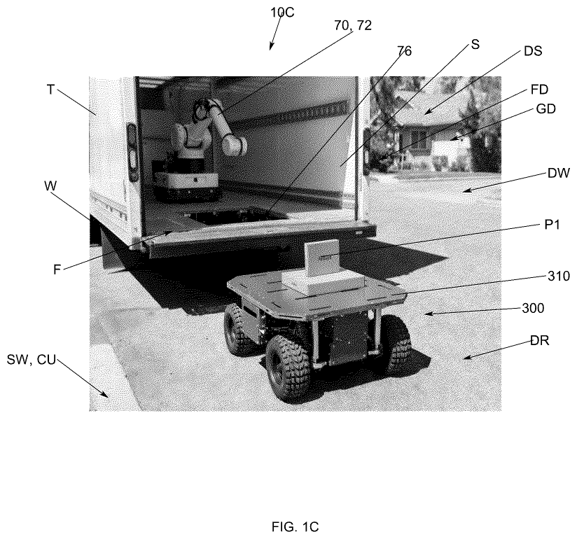

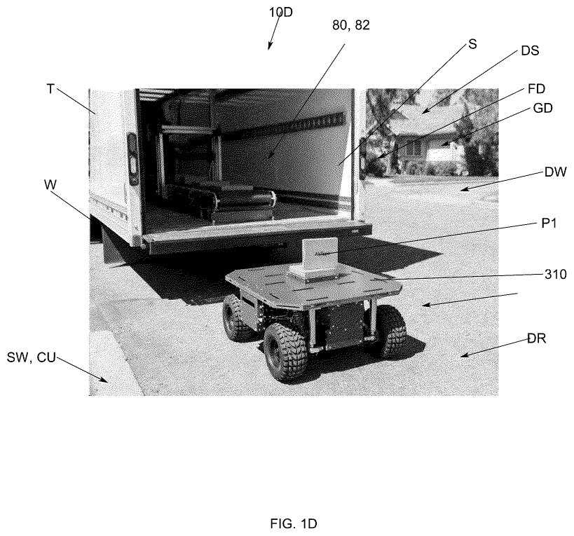

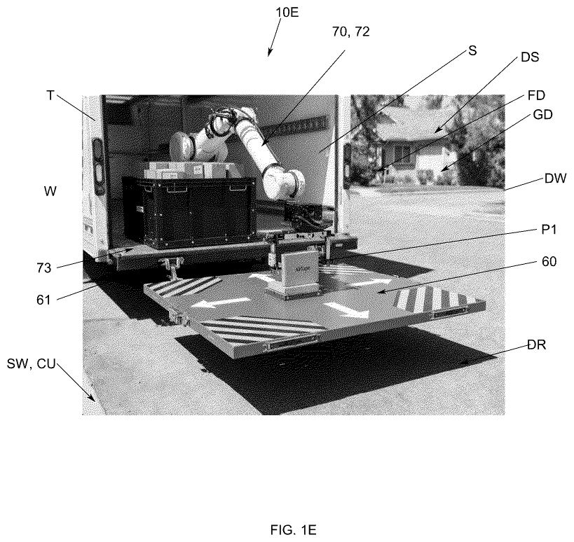

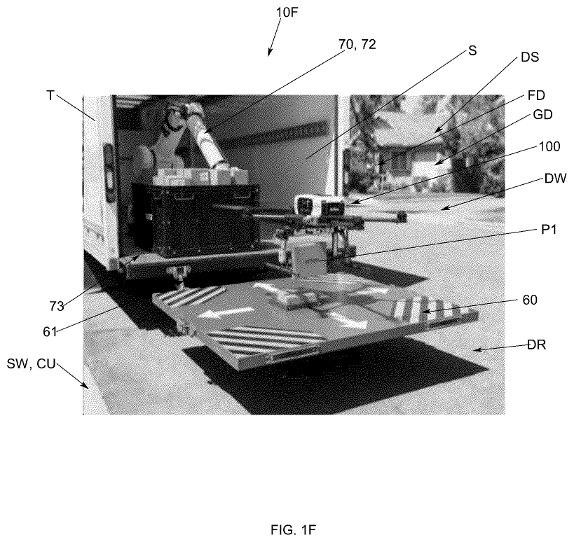

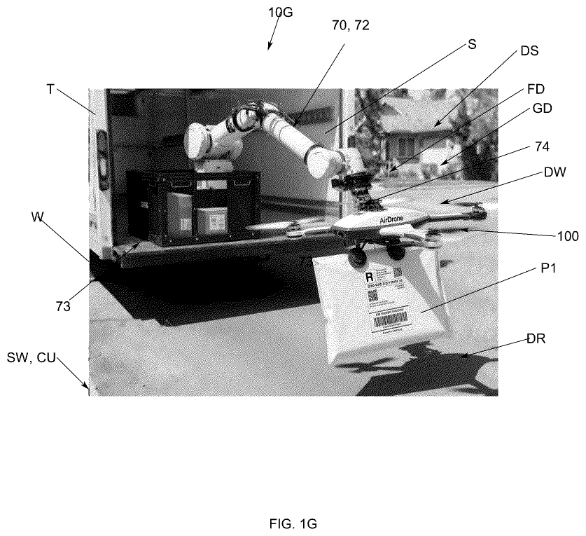

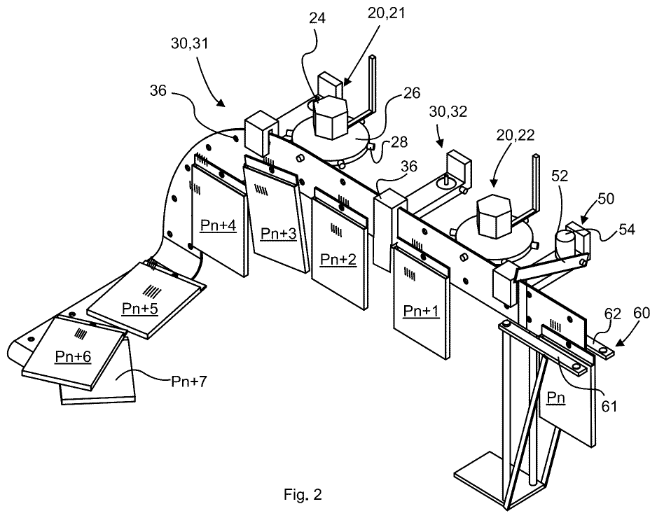

Referring now to FIGS. 1, 2, and 3, there is illustrated a preferred embodiment of package handling system 10 integrated with manned or unmanned delivery vehicle, such as delivery truck T transporting one or more delivery packages P (each containing a product or widget Wn) or one or more sets of delivery packages P destined for a set of address on a route, such as delivery route DR having a series of package drops, such as delivery stops DS of one or more packages, such as delivery packages Pn, Pn+1, Pn+2, Pn+3, Pn+4, Pn+5, Pn+6, Pn+7, and so on affixed or removeably affixed in series to a package feed tape, such as package feed tape 12 being transported to individual addresses or delivery stops DS along delivery route DR. Each package P may contain an address or machine readable code 34, such as a bar code or RFID tag (package information) that can be scanned by code reader, such as package reader 30, 31, 32 to designate a section or segment of package feed tape 12, which has package P affixed thereto, and transmit such information to microprocessor or controller 40 to control delivery or hand off of packages P affixed to package feed tape 12 to drone platform 60.

Ribbon, such as package feed tape 12 may include a plurality of holes, rows of, gripping teeth, or series of feed tape apertures 14 and one or more delivery packages P may be affixed or removeably affixed in series to package feed tape 12 or one or more delivery packages P may be pivotably affixed or removeably affixed in series to package feed tape 12. Package feed tape 12 (or feed tape 12) may contain an address or machine readable code 33, such as bar code or RFID tag (package information) that can be scanned by machine code reader, such as tape reader 30, 31, 32 and transmitted to microprocessor or controller 40 to control, determine, delineate delivery of packages P affixed to package feed tape 12 to drone platform 60 or control, determine, delineate one delivery package P of one or more delivery packages Pn (Pn+1, Pn+2, Pn+3, Pn+4, Pn+5, Pn+6, Pn+7) affixed to package feed tape 12.

It is contemplated that in order to precisely drive package feed tape 12 then package feed tape 12 may be configured with a gripping surface to prevent slippage of feed tape drive mechanism.

Package feed tape 12 may be fed into feed tape mechanism 20, 21, 22 affixed to, for example, sidewall S of delivery truck T and configured to drive, push and pull, or move (to propel) feed tape 12 in preferably linear motion toward drone platform 60. Package feed tape 12 may be fed into feed tape mechanism 20 and tape cutter 50 to start the sequence of package feed tape 12. Moreover, package handling system 10 may include delivery microprocessor or controller 40 controls(ing) feed tape mechanism 20, 21, 22 having drive motor 24, connected to drive wheel 26, having for example plurality of pins or pegs 28 positioned on a perimeter of drive wheel 26 to engage feed tape apertures 14 of package feed tape 12 to feed delivery packages Pn, Pn+1, Pn+2, Pn+3, Pn+4, Pn+5, Pn+6, Pn+7 to drone platform 60 and unmanned aerial vehicle, such as drone 100 according to a sequence in delivery route DR and pre-loaded with contents according to such sequence of delivery stops DS in a delivery route DR of delivery truck T (delivery stop sequence).

Microprocessor or controller 40 to control(s) feed tape mechanism 20, 21, 22 based on predetermined delivery route DR of delivery truck T route (confirmed by GPS location or position) and sequence, or series of delivery packages Pn, Pn+1, Pn+2, Pn+3, Pn+4, Pn+5, Pn+6, Pn+7 being pre-loaded with widgets Wn according to such delivery sequence of delivery stops DS in delivery route DR of delivery truck T (delivery stop sequence) and confirmed by microprocessor or controller 40, which controls package reader 30, 32, tape reader 30, 31 having machine code reader 36 positioned proximate or close in distance package feed tape 12 to enable reading of machine readable code 33, 34, feed tape mechanism 20, 21, 22 and together with delivery truck T, GPS location or position and sequence in delivery stops DS of delivery route DR to control, determine, or delineate one delivery package P of delivery packages Pn (Pn+1, Pn+2, Pn+3, Pn+4, Pn+5, Pn+6, Pn+7) to be delivered to delivery stops DS in delivery route DR.

It is contemplated herein that feed tape mechanism 20, 21, 22 may be utilized in a reverse feed via feed tape mechanism 20, 21, 22 to automatically load delivery truck T with delivery packages Pn, Pn+1, Pn+2, Pn+3, Pn+4, Pn+5, Pn+6, Pn+7 being pre-loaded with widgets Wn according to such delivery sequence of delivery stops DS in delivery route DR of delivery truck T.

Package handling system 10 may further include tape separator or tape cutter 50 having cutter mechanism 52 and drive mechanism 54 positioned proximate or close in distance package feed tape 12. Microprocessor or controller 40 controls tape cutter 50 based on predetermined delivery truck T route (confirmed by GPS location or position), delivery stops DS of delivery route DR, and sequence of series of delivery packages Pn, Pn+1, Pn+2, Pn+3, Pn+4, Pn+5, Pn+6, Pn+7 being pre-loaded with contents, such as widget Wn, according to such sequence of delivery stops DS of delivery route DR of delivery truck T and confirmed by delivery microprocessor or controller 40, which controls tape cutter 50 to cut, separate, release, or sever, for example, delivery package Pn from delivery packages Pn+1, Pn+2, Pn+3, Pn+4, Pn+5, Pn+6, Pn+7 to enable transfer of delivery package Pn to unmanned aerial vehicle, such as drone 100, which may be configured to pick up package Pn, and thereafter respectively next Pn+1 from Pn+2, Pn+3, Pn+4, Pn+5, Pn+6, Pn+7 and so on in sequence and deliver each delivery package Pn to such sequence of delivery stops DS of delivery route DR of delivery truck T (delivery stop sequence).

Package handling system 10 may further include one or more unmanned aerial vehicle platforms, such as drone platform 60, preferably having pair of spaced apart landing pads 61, 62 to enable delivery package Pn to be sequentially delivered one by one or combinations of delivery packages Pn and Pn+1 by microprocessor or controller 40, feed tape mechanism 20, and tape cutter 50 between landing pads 61, 62 positioned proximate or close in distance to feed tape mechanism 20, and tape cutter 50. Microprocessor or controller 40 controls tape cutter 50 based on predetermined delivery truck T route (confirmed by GPS location or position) and sequence of series of delivery packages Pn, Pn+1, Pn+2, Pn+3, Pn+4, Pn+5, Pn+6, Pn+7 being pre-loaded with contents, such as widget Wn, according to such sequence of delivery stops DS of delivery route DR of delivery truck T and confirmed by microprocessor or controller 40 controls tape cutter 50 to cut, separate, release, or sever, for example, delivery package Pn from delivery packages Pn+1, Pn+2, Pn+3, Pn+4, Pn+5, Pn+6, Pn+7 to enable unmanned aerial vehicle, such as drone 100 to pick up of package Pn, and thereafter respectively next Pn+1 from Pn+2, Pn+3, Pn+4, Pn+5, Pn+6, Pn+7 and so on in sequence therefrom landing pads 61, 62 to deliver delivery packages Pn in sequence to delivery stops DS of delivery route DR of delivery truck T (delivery stop sequence).

It is contemplated that delivery truck T may include a container, such as catch bin 70 affixed to delivery truck T to enable drone 100 to deposit package Pn that is not deliverable (undeliverable) so delivery truck T and drone 100 can move on to the next delivery stop DS for delivery package Pn+1.

Referring now to FIGS. 1A and 1B, there is illustrated a preferred embodiment of package handling system 10A integrated with manned or unmanned delivery vehicle, such as delivery truck T transporting one or more delivery packages P (each containing a product or widget Wn) or one or more sets of delivery packages P destined for a set of address on a route, such as delivery route DR having a series of package drops, such as delivery stops DS of one or more packages, such as delivery packages Pn, Pn+1, Pn+2, Pn+3, Pn+4, Pn+5, Pn+6, Pn+7, and so on being transported to individual addresses or delivery stops DS along delivery route DR.

Package handling system 10A is configured to transfer one or more delivery packages Pn from inside delivery vehicle T to an autonomous rover 300 for final “last-mile” delivery to a customer doorstep FD, garage door GD, patio or other designated location by rover 300 traversing from delivery vehicle T to the designated location and dropping delivery package(s) Pn.

FIG. 1A illustrates an alternate embodiment operational configuration of package handling system 10A. Delivery vehicle T is shown with its rear cargo door open, positioned at curbside CU delivery location adjacent to street DR, sidewalk SW, and curb CU. Mounted inside cargo area of delivery vehicle T may be robotic arm system 70, 72 secured to a base of delivery vehicle T. Robotic arm 70, 72 may be equipped with end effector 74 configured to grasp and transfer packages from delivery vehicle T to rover 300. It is contemplated herein that end effector 74 may utilize gripping, suction, magnetism and the like to grab hold of delivery package(s) Pn.

Autonomous rover 300 may be positioned on the sidewalk SW, street S, driveway DW or the like proximate delivery vehicle T and/or robotic arm system 70, 72 to receive delivery package(s) Pn drop from robotic arm system 70, 72.

Rover 300 may include platform 310 supported by a plurality of wheels, such as four wheels 320 and suspension posts 322. A single delivery package Pn is shown being transferred by robotic arm system 70, 72 directly onto rover platform 310. In the background, a suburban delivery stop environment is shown, including house DS, driveway DW, front door FD, and garage door GD, illustrating the final destination of rover 300 and delivery package(s) Pn.

It is contemplated herein that rover 100 may utilize actuator, hydraulic cylinder, or servo-driven linkage, such as actuator 328 to raise and lower platform 310, for example to center engage palleted deliver package Pn, to dump delivery package(s) Pn from rover platform 310.

It is contemplated herein that rover 100 with actuator 328 to raise and lower platform 310 may traverse up and down drone platform 60 (shown below) utilized as a ramp for rover 100 to traverse in and out of the cargo area of delivery vehicle T to retrieve palleted delivery packages Pn.

FIG. 1B illustrates alternate embodiment operational configuration of same package handling system 10B. In this view, storage bin or container B, 73 is preferably filled with multiple delivery packages Pn and positioned inside the rear cargo area of delivery vehicle T. Robotic arm system 70, 72 is shown actively reaching into bin B, 73 to retrieve package Pn. End effector 74 of the robotic arm system 70, 72 is in the process of lifting and transferring package Pn from bin B, 73 onto platform 310 of autonomous ground rover 300, which remains positioned on street S, sidewalk SW, driveway DW, or the like proximate delivery vehicle T and/or robotic arm system 70, 72. This configuration demonstrates the system's ability to handle batch-loaded packages stored in a centralized bin B, 73 within delivery vehicle T.

It is contemplated herein that bin B, 73 may include a closure with sidewalls and a top or be heat/cold retaining or regulating closure to transport delivery package Pn requiring temperature control.

Likewise, it is contemplated herein that delivery package Pn may include a closure with sidewalls and a top or be heat/cold retaining or regulating closure to transport widget Wn requiring temperature control.

In both FIGS. 1A and 1B, robotic arm system 70, 72 operates under computer control and is synchronized with delivery vehicle T location and autonomous ground rover 300 location via wireless communication. Rover 300 may remain stationary during package loading or may perform minor autonomous positioning adjustments. Once delivery package Pn is securely placed on rover platform 310, rover 300 is configured to autonomously navigate away from delivery vehicle T along the delivery route DR to complete the final “last-mile” delivery to the designated delivery stop DS (e.g., front door FD, garage door GD, driveway DW, or the like). Robotic arm system 70, 72 eliminates the need for manual handling at the truck-to-rover interface, while rover 300 provides efficient, contactless final delivery.

Various modifications and alternative embodiments of the package handling system shown in FIGS. 1A and 1B will be apparent to those skilled in the art without departing from the spirit and scope of the invention as defined by the appended claims.

It is contemplated herein that drone 100 may be positioned proximate drone platform 60 to receive delivery package(s) Pn from robotic arm system 70, 72.

It is contemplated herein that one or more unmanned aerial vehicle platforms, such as drone platform 60 enabling robotic arm system 70, 72 and end effector 74 to place delivery package Pn on rover platform 310 for pickup and delivery to designated delivery stop DS by drone 100.

It is contemplated herein that rover platform 310 may be configured with rover landing guides, rover holding mechanisms to secure rover 100 to delivery vehicle T, rover charging quick connects, rover communication quick connects, and the like to assist navigation between rover 300 and delivery vehicle T and to recharge, communicate with rover 300, and assist with delivery package Pn pickup by rover 300.

Referring now to the drawings, and in particular to FIG. 1C, there is shown a third operational embodiment of package handling system 10C. FIG. 1C illustrates package handling system 10C configured for transfer of one or more delivery packages Pn from inside delivery vehicle T to an autonomous ground rover 300 through aperture 76 in delivery vehicle T floor or sidewall S. Delivery vehicle T is shown with its rear cargo door open, positioned at a curbside delivery location adjacent to a street DR, sidewalk SW, curb CU, or the like of delivery stop DS. Mounted inside the cargo area of delivery vehicle T is preferably robotic arm system 70, 72 secured to a base. Robotic arm system 70, 72 is equipped with end effector 74 configured to grasp and manipulate packages Pn. An access hole, such as aperture 76 may be formed in floor F, sidewall S, or the like of delivery vehicle T cargo area, providing a direct pathway from the interior of the truck to the exterior for robotic arm system 70, 72 via aperture 76. Autonomous ground rover 300 is preferably positioned on the street DR, sidewalk SW, driveway DW, under delivery vehicle T, or the like proximate aperture 76.

A single delivery package Pn is shown having been transferred through aperture 76 and now resting securely on rover platform 310.

In this embodiment, robotic arm system 70, 72 operates under computer control and is synchronized with autonomous ground rover 300 via wireless communication. Packages Pn may be staged directly above or dropped or positioned through aperture 76. Robotic arm system 70, 72 then retrieves or guides the package through the aperture 76 and places it onto rover platform 310. Once delivery package Pn is securely placed on rover platform 310, rover 300 autonomously navigates away from delivery vehicle T along the delivery route DR to complete the final “last-mile” delivery to designated delivery stop DS.

It is contemplated herein that aperture 76 may lead to one or more unmanned aerial vehicle platforms, such as drone platform 60 enabling robotic arm system 70, 72 and end effector 74 to place delivery package Pn on rover platform 310 for pickup and delivery to designated delivery stop DS by drone 100.

The package handling system herein enables vertical integration between multiple deck levels or automated feed systems inside the truck and the ground-level rover transfer, eliminating the need for manual handling at the truck-to-rover interface while maintaining high throughput and precision in e-commerce fulfillment operations.

Various modifications and alternative embodiments of the package handling system shown in FIG. 1C will be apparent to those skilled in the art without departing from the spirit and scope of the invention as defined by the appended claims.

Referring now to the drawings, and in particular to FIG. 1D, there is shown a fourth operational embodiment of package handling system 10D. FIG. 1D illustrates package handling system 10D configured for automated transfer of one or more delivery package(s) Pn from inside delivery vehicle T to rover platform 310 of autonomous ground rover 300 via integrated conveyor system 80, 82. Delivery vehicle T is shown with its rear cargo door open, positioned at a curbside delivery location adjacent to a street S, sidewalk SW, driveway DW, curb CU, or the like. Mounted inside the cargo area of delivery vehicle T is preferably conveyor system 80 generally designated to include conveyor mechanism components 82. Conveyor system 80 may be configured to propel delivery package(s) Pn along a linear path toward open rear door of delivery vehicle T, aperture 76, or drone platform 60. Autonomous ground rover 300 may be positioned proximate street S, sidewalk SW, driveway DW, curb CU, and the like or to receive delivery package(s) Pn from conveyor system 80. Alternatively, drone 100 may be positioned proximate drone platform 60 to receive delivery package(s) Pn from conveyor system 80 thereon drone platform 60. It is contemplated herein one or more unmanned aerial vehicle platforms, such as drone platform 60 utilizing conveyor system 80 to place delivery package Pn on drone platform 60 for pickup and delivery by drone 100 to designated delivery stop DS by drone 100.

Delivery packages are fed onto conveyor system 80 from one or more package handling system 10, package handling system 10A, package handling system 10B, or other package push systems to push or place package from shelf, cubby, or bin onto conveyor system 80 in order of delivery and are automatically propelled outward through the open rear door or aperture 76 of delivery vehicle T. Conveyor system 80 deposits delivery package Pn directly onto rover platform 310 or drone platform 60.

Package handling system 10D provides a fully automated, conveyor-driven transfer interface that eliminates the need for manual handling at the truck-to-rover or truck-to-drone handover point. This configuration integrates seamlessly with other embodiments, and other components described elsewhere in this specification, enabling high-throughput hybrid truck-rover (and truck-drone, truck-drone-rover) delivery workflows while maintaining precision and efficiency in e-commerce fulfillment operations.

Various modifications and alternative embodiments of the conveyor-based package handling system shown in FIG. 1D will be apparent to those skilled in the art without departing from the spirit and scope of the invention as defined by the appended claims.

It is contemplated herein that a chute may be utilized to transition between truck-rover, truck-drone, truck-drone-rover.

Package handling system 10D is configured to transfer one or more delivery packages Pn from inside delivery vehicle T to an autonomous ground rover 300 for final “last-mile” delivery to a customer doorstep FD, garage door GD, patio or other designated location by rover 300 traversing from delivery vehicle T to the designated location and dropping delivery package(s) Pn.

Referring now to the drawings, and in particular to FIG. 1E, there is shown a fourth operational embodiment of package handling system 10E. FIG. 1E illustrates an alternate embodiment operational configuration of package handling system 10E. Delivery vehicle T is shown with its rear cargo door open, positioned at curbside CU delivery location adjacent to street DR, sidewalk SW, curb CU, or the like. Mounted inside cargo area of delivery vehicle T may be robotic arm system 70, 72 secured to a base of delivery vehicle T. Robotic arm 70, 72 may be equipped with end effector 74 configured to grasp and transfer delivery packages Pn from delivery vehicle T to drone platform 60.

Referring again to the drawings, and in particular to FIG. 1E, there is illustrated a preferred embodiment of package handling system 10E in which robotic arm 70, 72 picks delivery package Pn from storage bin 73 inside delivery truck T and places it onto the hinged-door drone platform 60. Delivery truck T is positioned at a curbside delivery location with its rear cargo door open, revealing storage bin 73 filled with delivery package Pn. Robotic arm 70, 72, mounted inside the cargo area, extends outward through open rear door or aperture 76 to position one of delivery package Pn on drone platform 60.

The drone platform 60 may be a flat, reinforced metal structure hingedly attached to the truck's rear tailgate/bumper assembly 61, sidewall S, ceiling, or the like, allowing it to pivot downward into horizontal operating position or upward into a stowed travel position. Drone platform 60 surface includes yellow-and-black alignment markings, landing pads for precise drone capture, and power strip to charge drone 100 while sitting on drone platform 60.

It is contemplated herein that drone platform 60 may be positioned inside delivery truck T.

It is contemplated herein that drone platform 60 may include drone 100 anchor system, auxiliary power connection, battery charge connection, communication connection, and the like as well as drone 100 has similar quick connections as well.

It is contemplated herein that mechanically hingeable and auto actuated drone platform 60 may be utilized as a ramp for rover 100 to traverse in and out through open door of delivery truck T. Moreover, drone platform 60 may include rover 300 anchor system, auxiliary power connection, battery charge connection, communication connection, and the like as well as rover 300 has similar quick connections as well.

It is contemplated herein that rover 300 may traverse up and down drone platform 60 utilized as a ramp for rover 100 to traverse in and out of the cargo area of delivery vehicle T to receive delivery packages Pn from robotic arm 70, 72 in the cargo area of delivery vehicle T.

It is contemplated herein that drone platform 60 may be positioned inside delivery truck T. In operation, the robotic arm 70, 72 reaches into storage bin 73, grasps the next sequenced delivery package Pn, and transfers it onto drone platform 60. Once the package is securely placed and confirmed by the system controller, drone 300 (not shown in this view but described elsewhere) lands on or approaches platform 60 to engage its capture mechanism and grasp delivery package Pn. The hinged design of drone platform 60 enables rapid deployment from the truck's rear without requiring the drone to enter the enclosed cargo area, while also allowing the platform to be folded upward for highway transport. This configuration integrates seamlessly with the feed-tape mechanism, tape cutter, conveyor system 10D, rover embodiments, and drone-pickup system of FIG. 1F, providing a fully automated, contactless handover that eliminates manual handling and supports high-throughput hybrid truck-drone last-mile delivery workflows along the delivery route DR to the designated delivery stop DS.

Various modifications and alternative embodiments of the robotic-arm-to-hinged-drone-platform system shown in FIG. 1F will be apparent to those skilled in the art without departing from the spirit and scope of the invention as defined by the appended claims.

It is contemplated herein that drone platform 60 may be configured as part of a door to delivery vehicle T, or affixed or moveably hinged from rear bumper 61, sidewall S or other location on delivery vehicle T.

It is further contemplated herein that end effector 74 may utilize gripping, suction, magnetism and the like to grab hold of delivery package(s) Pn.

Drone 100 may traverse to drone platform 60 pickup delivery package(s) Pn for delivery of package Pn to designated delivery stop DS.

Package handling system 10E provides a fully automated, robotic arm-driven transfer interface that eliminates the need for manual handling at the truck-to-drone handover point. This configuration integrates seamlessly with other embodiments, and other components described elsewhere in this specification, enabling high-throughput hybrid truck-drone (truck-drone-rover) delivery workflows while maintaining precision and efficiency in e-commerce fulfillment operations.

Various modifications and alternative embodiments of the robotic-based package handling system shown in FIG. 1E will be apparent to those skilled in the art without departing from the spirit and scope of the invention as defined by the appended claims.

Package handling system 10E is configured to transfer one or more delivery packages Pn from inside delivery vehicle T to drone platform 60 for final “last-mile” delivery to a customer doorstep FD, garage door GD, driveway DW, patio, or other designated location by drone 100 traversing from delivery vehicle T to the designated location and dropping delivery package(s) Pn.

It is contemplated herein that drone platform 60 may be configured with drone landing guides, drone holding mechanisms to secure drone 100 to delivery vehicle T, drone charging quick connects, drone communication quick connects, and the like to assist navigation between drone 100 and drone platform 60 in windy conditions and to recharge, communicate with drone 100, and assist with delivery package Pn pickup by drone 100.

Referring now to the drawings, and in particular to FIG. 1F, there is illustrated a preferred embodiment of the package handling system 10F in which drone 100 autonomously picks up delivery package Pn directly from drone platform 60 mounted on, for example, the rear tailgate of the delivery truck T. Delivery truck T is shown with its rear cargo door open, positioned at a curbside delivery location adjacent to a street S, sidewalk SW, curb CU, or the like. A robotic arm 70, 72 (or associated conveyor mechanism) is visible inside the cargo area near storage bin 73 containing additional packages. Drone platform 60 may be a flat, reinforced structure with yellow-and-black alignment markings and arrow indicators, securely attached to the truck's rear bumper/tailgate hinge assembly 61. Delivery package Pn rests on drone platform 60, ready for immediate drone pickup.

In operation, drone 100 hovers directly above drone platform 60 and engages its underside capture mechanism with delivery package Pn. Once the package is securely attached, drone 100 lifts off and autonomously navigates along delivery route DR to the designated delivery stop DS (e.g., front door FD, garage door GD, driveway DW, or the like). Robotic arm 70, 72 and platform 60 may be synchronized via the system controller so that the next package Pn is already positioned or being advanced onto drone platform 60 as drone 100 departs. This configuration enables rapid, contactless handover without the drone entering the truck interior, integrating seamlessly with other embodiments described elsewhere in this specification, thereby providing a highly efficient hybrid truck-drone or truck,-rover-drone “last-mile” delivery workflow.

Various modifications and alternative embodiments of the drone-pickup system shown in FIG. 1F will be apparent to those skilled in the art without departing from the spirit and scope of the invention as defined by the appended claims.

Referring now to the drawings, and in particular to FIG. 1G, there is illustrated a preferred embodiment of the package handling system 10G in which robotic arm 70, 72 hands of delivery package Pn directly to drone 100. Package handling system 10G having robotic arm 70, 72 directly picks delivery package Pn from storage bin 73 inside delivery truck T and hands it off to drone 100 without an intermediate platform or rover. Delivery truck T is preferably positioned at proximate curbside CU or the like delivery location with its rear cargo door open. Robotic arm 70, 72, mounted inside the cargo area of delivery truck T with end effector 74 holding delivery package Pn, extends outward through the open rear door or aperture 73 positioning delivery package Pn for drone 100 handoff. Delivery package Pn is preferably securely gripped by end effector 74 and is being transferred directly to the hovering drone 100 whose capture mechanism 141/142 is mutually engaged with delivery package Pn.

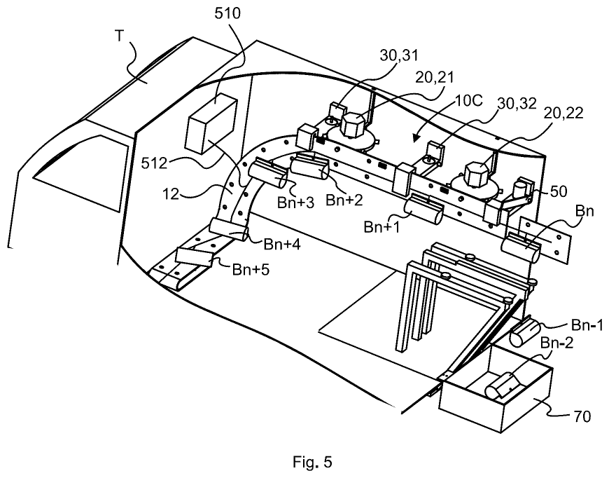

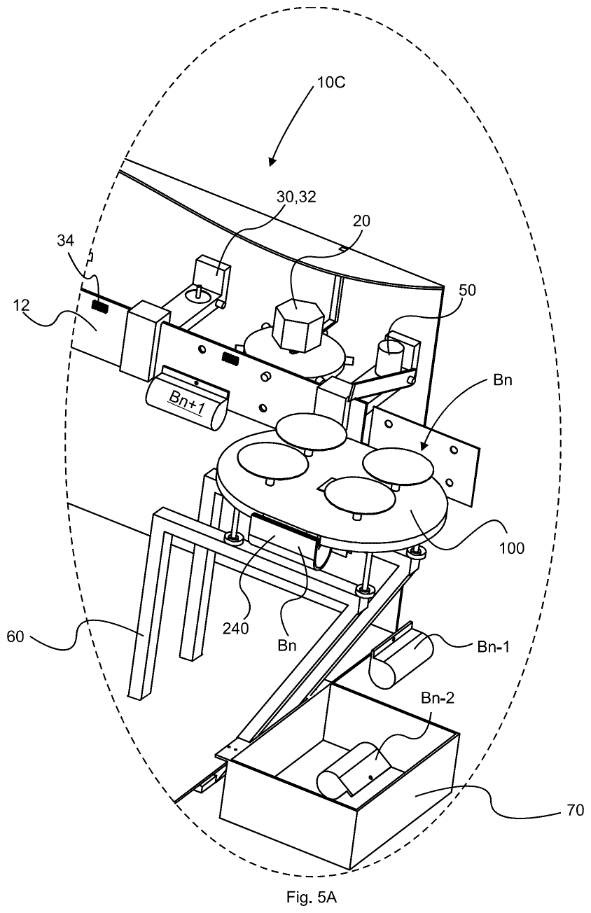

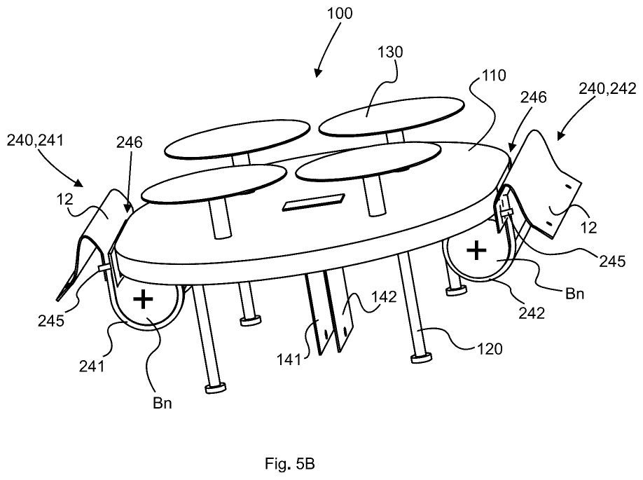

In operation, robotic arm 70, 72 reaches into storage bin 73, grasps the next sequenced delivery package P1, and extends it into the open air adjacent to the truck's rear opening. Drone 100 hovers in precise alignment with end effector 74, receives handoff of delivery package Pn via its integrated capture system 141, 142 (shown in FIG. 5B), and confirms secure attachment to the system controller. Once the handoff is verified, drone 100 departs and autonomously navigates along delivery route DR to designated delivery stop DS (e.g., front door FD, garage door GD, or driveway DW).

This direct robot-to-drone handoff eliminates the need for an intermediate drone platform or conveyor, enabling faster cycle times while maintaining full automation. The embodiment shown in FIG. 1G integrates seamlessly with other embodiments elsewhere in this specification, providing maximum flexibility in hybrid truck-robot-drone “last-mile” delivery workflows.

Various modifications and alternative embodiments of the robotic-arm-to-drone direct handoff system shown in FIG. 1G will be apparent to those skilled in the art without departing from the spirit and scope of the disclosure as defined by the appended claims.

It is contemplated herein that robot-to-drone handoff may occur inside cargo area of delivery truck T or inside a wind shielded area formed by flap extensions extending from the rear or sidewall S of delivery truck T.

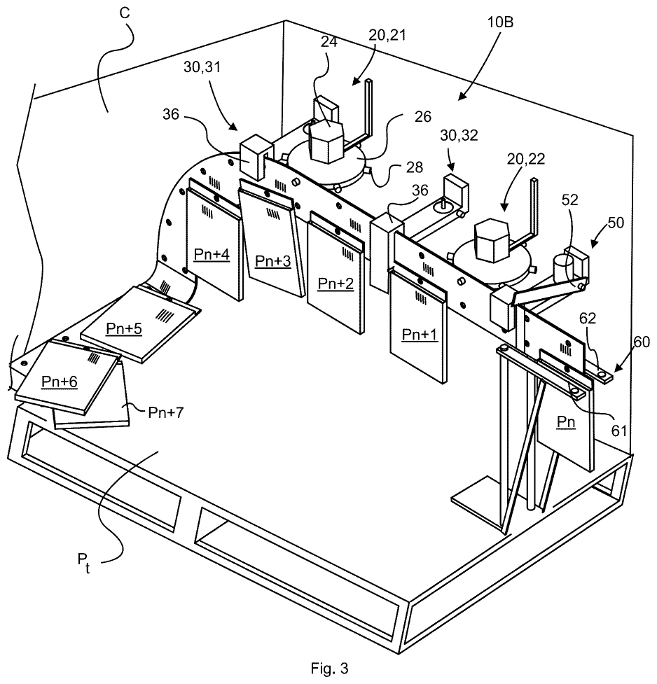

It is contemplated herein in FIG. 3 that package handling system 10B may be housed in or on packager or container C and positioned on palate Pt or just positioned on palate Pt (palleted delivery package) for moving via a fork truck to load one or more package handling system 10B onto delivery truck T.

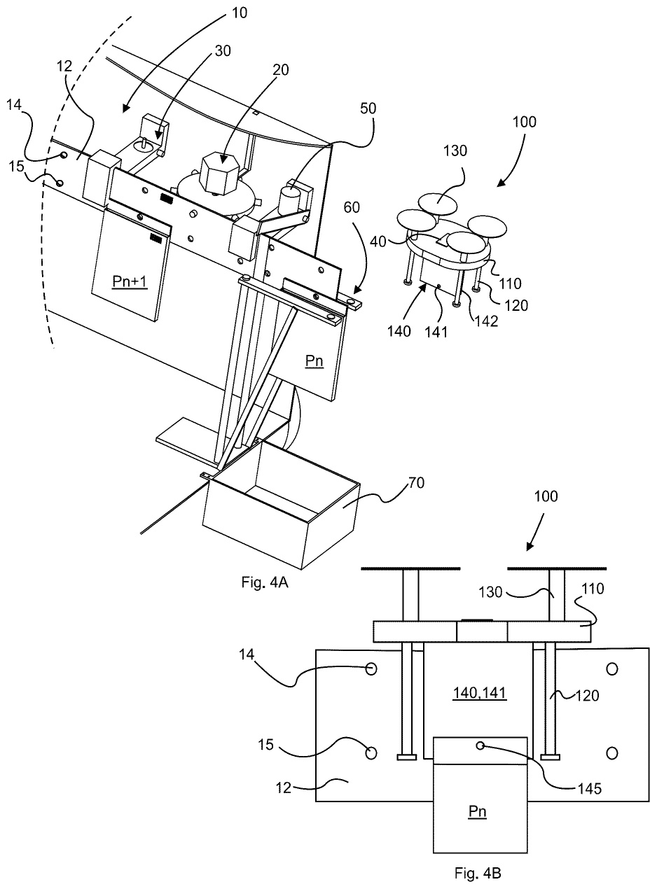

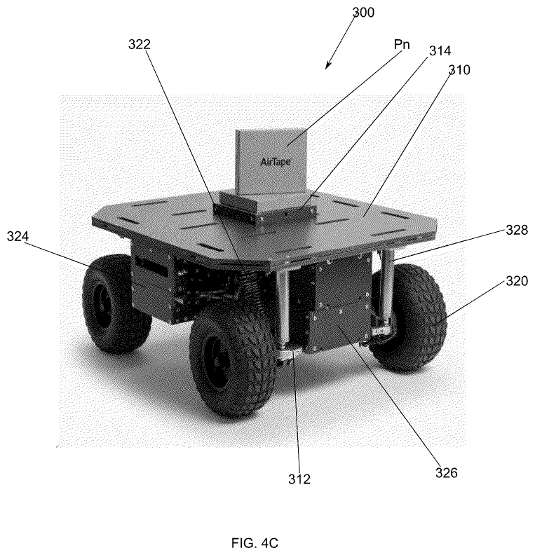

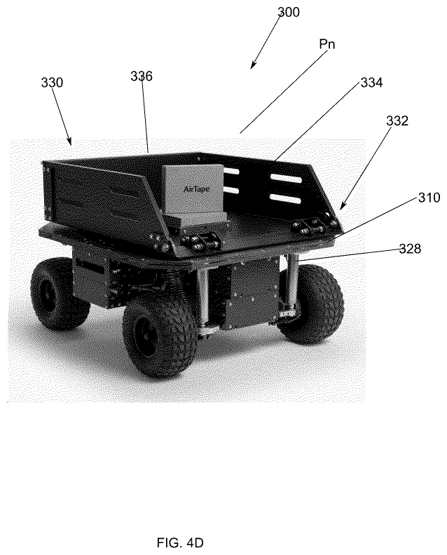

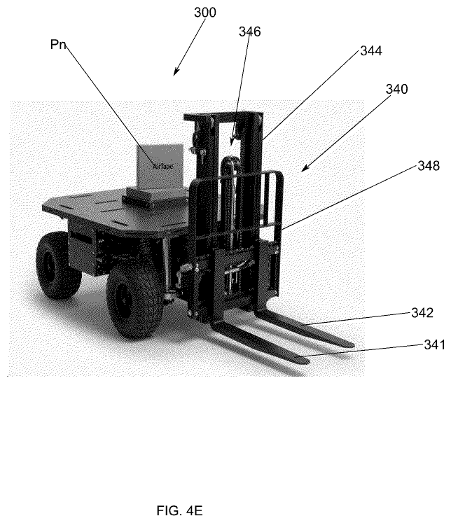

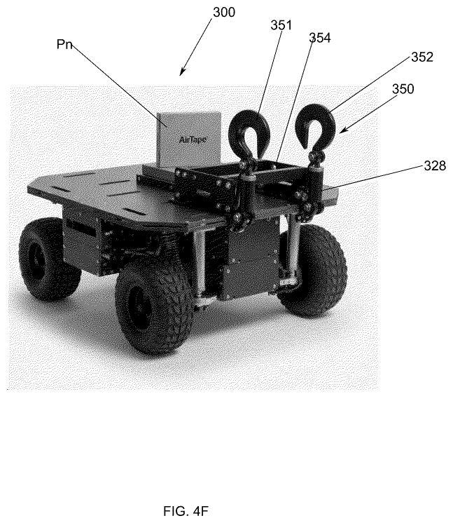

Referring now to FIGS. 1, 4A, and 4B, there is illustrated a preferred embodiment of one or more package handling system 10, one or more delivery platforms 60, and one or more drone 100. Drone 100 may include drone microprocessor or controller 40 to control navigation of drone 100 and communicate with delivery microprocessor or controller 40, preferably for short haul delivery of package Pn to address of delivery stops DS of delivery route DR of delivery truck T. Drone 100 may include body 110, landing structure(s) 120 connected to body 110 and two or more drive motors with power supplies and lift and guidance propellers 130 to navigate drone 100. Moreover, drone 100 may include drone feed tape capture system 140, such as slotted feed tape receiver, preferably affixed to body 110 or landing structure(s) 120. Drone feed tape capture system 140 may include a slotted tape receiver, such as gapped or spaced apart first receiver member 141 and second receiver member 142 with catch pin 145 or the like to insert therein feed tape apertures 14 of feed tape 12 or secure feed tape 12 therein to secure package Pn to drone feed tape capture system 140 of drone 100 for transport and drop off to delivery stops DS of delivery route DR of delivery truck T.

It is contemplated herein that and the like of first receiver member 141 and second receiver member 142 with catch pin 145 or the like end may utilize gripping, suction, magnetism and the like to grab hold of delivery package(s) Pn.

First step, drone 100 lands on drone pad 60 as shown in FIG. 1. Delivery microprocessor or controller 40 detects drone 100 is in positions on drone platform 60 or drone 100 communicates same to delivery microprocessor or controller 40. Next step, package handling system 10 feeds or moves package feed tape 12 through feed tape mechanism 20 and feed tape mechanism 20 moves or pushes or pulls package feed tape 12 to drone platform 60 and preferably between pair of spaced apart landing pads 61, 62 into drone feed tape capture system 140. Where drone feed tape capture system 140 grips or slides catch pin 145 in to feed tape apertures 14 of package feed tape 12 to secure package Pn to drone feed tape capture system 140 of drone 100.

Drone 100 communicates to delivery microprocessor or controller 40 of package handling system 10 that feed tape and delivery package Pn is secure in drone feed tape capture system 140. Delivery microprocessor or controller 40 initiates tape cutter 50 to cut, separate, release, or sever, for example, package Pn from Pn+1, Pn+2, Pn+3, Pn+4, Pn+5, Pn+6, Pn+7 and so on.

Drone 100 transports package Pn to addressed delivery location, delivery stops DS of delivery route DR from delivery truck T via drone navigation algorithm, such as navigation to front door, garage (drone trigger garage to open & close), porch, drop box, or other designated delivery location and releases catch pin 145 to deposit package Pn there. Drone 100 navigates and returns to drone platform 60 to pick up package Pn+1 next. Delivery truck T moves to next address location Pn+1. Repeat for Pn+2, Pn+3, Pn+4, Pn+5, Pn+6, Pn+7 and so on in sequence (delivery stop sequence).

Referring now to FIGS. 4C, 4D, 4E, and 4F, there is illustrated a preferred embodiment of rover 300. Rover 300 may be supported by a plurality of wheels, such as four wheels 320, frame, such as main body 312, suspension system 322, drive mechanism 324, motor or power supply, such as battery pack 326, and platform tilt, servo, or hydraulics, such as actuator 328.

Referring now to FIGS. 4C, 4D, 4E, and 4F, the autonomous rover 300 that receives the delivery package Pn from delivery truck T. Rover 300 may be self-propelled, all-terrain autonomous delivery vehicle configured to accept delivery package Pn directly from delivery truck T discharge point and to autonomously navigate the final “last-mile” segment of delivery route DR to the designated delivery stop DS (e.g., front door FD, garage door GD, or driveway DW).

As seen in FIGS. 4C, 4D, 4E and 4F, rover 300 is supported by a plurality of wheels 320, illustrated as four rugged, all-terrain pneumatic or solid-rubber tires mounted on a robust chassis. Wheels 320 are connected to chassis or main body 312 of the rover via suspension system 322 that provides stable ride height and dampen road vibrations during autonomous travel on sidewalks, driveways, and uneven surfaces. Drive mechanism 324 (including motors, gearboxes, and wheel encoders) may be integrated or connected to main body 312 to enable precise differential steering and propulsion. Power is supplied by an onboard motor or power supply, illustrated as battery pack 326 housed within the lower central portion of the chassis for optimal weight distribution and easy field replacement. Platform 310 may be mounted atop main body 312 and is further equipped with a platform tilt or hydraulic/servo actuator 328 (shown as gold-anodized or powder-coated vertical actuators) that allows controlled tilting or leveling of the platform 310 to facilitate secure delivery package Pn placement thereto platform 310 and stable transport of delivery package Pn.

In operation (as shown in FIG. 1A-1D), package handling system 10 delivers delivery package Pn outward from delivery truck T cargo area and deposits it centrally onto rover platform 310. Actuator 328 may momentarily adjust platform angle to ensure delivery package Pn seats securely against alignment features on the platform surface. Platform 310 may include delivery package gripping mechanism 314 to secure delivery package Pn to rover platform 310. Once delivery package Pn is confirmed as loaded (via onboard sensors or wireless confirmation from the truck controller), rover 300 autonomously departs from delivery truck T, navigates along the pre-mapped delivery route using GPS, computer vision, and obstacle-avoidance sensors (similar to drone 100), and delivers delivery package Pn to the customer doorstep or designated location or designated delivery stop DS (e.g., front door FD, garage door GD, driveway DW, or the like) without human intervention.

Rover 300 embodiment illustrated in FIGS. 4C-4E integrates seamlessly with package handling system 10, the robotic-arm and conveyor embodiments of FIGS. 1A-1C, the feed-tape mechanism, and the drone platform described elsewhere in this specification. This modular design enables hybrid truck-conveyor-rover, truck-robotic-arm-rover, and truck-rover-drone workflows, providing maximum flexibility for high-throughput e-commerce fulfillment while eliminating manual handling at the vehicle-to-delivery interface.

Various modifications and alternative embodiments of the rover 300 and its integration with package handling system 10 and 4C-4F will be apparent to those skilled in the art without departing from the spirit and scope of the invention as defined by the appended claims.

It is contemplated herein that platform 310 may include a closure with sidewalls and a top or heat/cold retaining or regulating closure to transport delivery package Pn requiring temperature control.

Referring again to FIG. 4D, there is illustrated an alternative embodiment of the autonomous ground rover 300 equipped with dump bucket 330 for automated, contactless release of delivery package Pn at the customer delivery stop DS. Rover 300 retains the same rugged four-wheel chassis, suspension system 322, drive mechanism 324, battery pack 326, and base platform 310 as described in the flat-platform embodiment of FIG. 4C. Mounted atop the platform 310 may be rectangular dump bucket 330 fabricated from lightweight, high-strength sheet metal, plastic, composite, or like material with reinforced sidewalls 334 and rear wall 336. Dump bucket 330 is pivotally attached to platform 310 along its front edge by one or more robust hinges 332 that permit controlled rotation of the bucket from a horizontal transport position to an inclined dumping position.

In operation, once rover 300 has autonomously navigated to the precise delivery location (e.g., front door FD, driveway DW, or garage door GD), an onboard electric linear actuator, hydraulic cylinder, or servo-driven linkage, such as actuator 328 (operatively connected apart from hinges 332) is energized by rover controller. Actuator 328 rotates dump bucket 330 about hinges 332, tilting the bucket forward or rearward at a predetermined angle sufficient to allow delivery package Pn to slide or roll out under gravity onto the ground or designated drop zone, such as delivery location (e.g., front door FD, driveway DW, garage door GD, or the like) without requiring manual intervention or additional robotic grippers. After delivery package Pn has been released, actuator 328 reverses direction to return dump bucket 330 to its flat transport position, ready for the next delivery cycle. Dump-bucket 330 configuration of rover 300 integrates seamlessly with the conveyor system 10D of FIG. 1D, the robotic-arm transfer embodiments of FIGS. 1A-1C, and the feed-tape mechanism, providing a simple, reliable, and low-maintenance mechanism for final package deposition while maintaining full autonomy throughout the “last-mile” delivery workflow.

Referring now to FIG. 4E, there is illustrated yet another alternative embodiment of the autonomous ground rover 300 equipped with an integrated forklift mechanism 340 for versatile package handling and vehicle docking. Forklift mechanism 340 may be mounted to the forward edge of rover platform 310 and having a vertical support structure or mast 344 rigidly affixed to rover chassis 312, a movable carriage 348 that travels vertically along mast 344, and a pair of parallel forks consisting of first fork 341 and second fork 342. Back brace or load backrest 348 extends upward from first fork 341 and second fork 342 to prevent delivery package Pn from shifting rearward during lifting and transport. The entire forklift assembly 340 is powered by the rover's onboard battery pack 326 and controlled by the rover controller, enabling fully autonomous lift, lower, and tilt operations synchronized with the delivery workflow.

In the primary package-delivery mode, the first fork 341 and second fork 342 are inserted beneath standard delivery pallet or directly under delivery package Pn. Lift mechanism 346, illustrated as a hydraulic or electrically driven scissor or chain-driven actuator housed within mast 344, raises carriage 348 and forks 341, 342 to a predetermined height, allowing rover 300 to lift palletized delivery package Pn clear of the truck bed of delivery vehicle T. Once palletized delivery package Pn is removed from delivery vehicle T and lowered to transport height, rover 300 autonomously navigates to the customer designated delivery stop DS (e.g., front door FD, driveway DW, garage door GD, or the like), where the forks are lowered to deposit palletized package Pn onto the ground or designated drop zone (e.g., front door FD, driveway DW, garage door GD, or the like) with precision. Back brace 348 ensures stable load retention throughout transit, while the dual-fork design provides balanced support for pallets ranging from small e-commerce envelopes, groceries, to larger consolidated loads and the like.

In a secondary vehicle-securing mode using hooks or the like, such as first fork 341 and second fork 342 are configured to engage corresponding receiver slots, pockets, undercarriage rails, or the like located on underside or rear bumper of delivery truck T. When rover 300 returns to the truck after a delivery, the forks are driven forward into the truck's docking receivers, and lift mechanism 346 is actuated to lower the forks slightly, thereby lifting rover 300 off the ground and locking rover 300 securely against docking receivers or tailgate for rover 300 transport between delivery stops. This dual-purpose forklift design eliminates the need for separate tie-downs or manual loading, enabling rapid, automated rover retrieval and redeployment while maintaining rover 300 in a stable, vibration-dampened position during truck movement. The forklift-equipped rover 300 of FIG. 4E therefore integrates seamlessly with the conveyor system 10D, robotic-arm embodiments, feed-tape mechanism, and drone platform described elsewhere in this specification, providing maximum operational flexibility in hybrid truck-rover delivery workflows.

It is contemplated herein that rover 100 with forklift mechanism 340 may traverse up and down drone platform 60 utilized as a ramp for rover 100 to traverse in and out of the cargo area of delivery vehicle T to retrieve palleted delivery packages Pn.

Referring now to FIG. 4F, there is illustrated yet another alternative embodiment of the autonomous ground rover 300 equipped with an integrated hook mechanism 350 for vehicle docking. Hook mechanism 350 may be mounted to the forward edge of rover platform 310 and having a pair of parallel forks consisting of first fork 351 and second fork 352.

In a secondary vehicle-securing mode using hooks or the like, such first fork 351 and second fork 352 are configured to engage corresponding receiver slots, rings, pockets, undercarriage hooks, or the like located on underside or rear bumper of delivery truck T. When rover 300 returns to the truck after a delivery, the hooks are driven forward into the truck's docking receivers, and actuator 328 is actuated to lower the hooks slightly, thereby lifting rover 300 off the ground and locking rover 300 securely against docking receivers or tailgate for rover 300 transport between delivery stops. This design eliminates the need for separate tie-downs or manual loading, enabling rapid, automated rover retrieval and redeployment while maintaining rover 300 in a stable, vibration-dampened position during truck movement. The hook-equipped rover 300 of FIG. 4F therefore integrates seamlessly with the conveyor system 10D, robotic-arm embodiments, feed-tape mechanism, and drone platform described elsewhere in this specification, providing maximum operational flexibility in hybrid truck-rover delivery workflows.

It is contemplated herein that first fork 351 and second fork 352 may be configured in different shapes to accommodate latch and unlatch with into the truck's docking receivers.

Referring now to FIGS. 5, 5A, and 5B, there is illustrated a preferred embodiment of one or more battery handling system 10C, one or more delivery platforms 60, and one or more drone 100. Battery handling system 10C having manned or unmanned delivery vehicle, such as delivery truck T transporting one or more drone battery packs, such as battery Bn, Bn+1, Bn+2 and so on affixed or removeably affixed in series to battery feed tape 12. Each battery B may contain machine readable code 34, such as bar code or RFID tag that can be scanned by code reader, such as battery reader 30, 32 and transmitted to microprocessor or controller 40 to control power supply to drone 100. Moreover, batteries Bn may be wired (electrically connected) together via wires 512 running along battery feed tape 12 to enable trickle charging via charger 510 so battery Bn, Bn+1, Bn+2 and so on remain in a state of full charge.

Drone 100 may include microprocessor or controller 40 to control(s) to control navigation of drone 100, short haul delivery of package Pn to address and communicate with delivery truck T. Drone 100 may include body 110, landing structure(s) 120 connected to body 110 and two or more drive motors and lift and guidance propellers 130 to navigate drone 100. Drone 100 may connect to auxiliary power, such as via charger 510 via platform 60 when docking. Moreover, drone 100 may include one or more drone battery feed tape capture system 240 preferably affixed to body 110 or landing structure(s) 120. Drone battery feed tape capture system 240 may include at least one battery receiver, or such as spaced apart first battery receiver 241 and second battery receiver 242 with catch pin 245 or the like to insert therein feed apertures 14 of battery feed tape 12 to secure battery Bn to drone feed tape capture system 140 (slotted battery receiver) of drone 100. It is contemplated at least one battery receiver, or such as spaced apart first battery receiver 241 and second battery receiver 242 may include receiver slot 246 to receive battery feed tape 12.

First step, drone 100 lands on drone pad 60 as shown in FIG. 1. Microprocessor or controller 40 detects drone 100 is in positions on drone platform 60 or drone 100 communicates same to microprocessor or controller 40 that drone power is low (low power). Next step, battery handling system 10C feeds, pushes or pulls, or moves battery feed tape 12 through battery feed tape mechanism 20 and battery feed tape mechanism 20 moves or pushes or pulls battery feed tape 12 to drone platform 60 and preferably into or through drone battery feed tape capture system 240. Where drone battery feed tape capture system 240 grips or slides catch pin 245 into feed tape apertures 14 of battery feed tape 12 to secure battery Bn to drone battery feed tape capture system 240 of drone 100 to supply drone 100 with newly charged battery system. Spent battery Bn−1 is pushed from at least one battery receiver, drone battery feed tape capture system 240, or such as spaced apart first battery receiver 241 and second battery receiver 242 and drops spent battery Bn−1 into catch bin 70 positioned below drone platform 60.

It is contemplated herein that drone 100 may have two or more batteries Bn and that drone 100 may service one set and then rotate thereon platform 60 to enable service of other set(s) of batteries Bn. Furthermore, first battery receiver 241 and second battery receiver 242 may be formed to make a partial or full enclosure therearound battery Bn.

It is contemplated herein that drone 100 may have two or more batteries Bn and that drone 100 may service two or more batteries Bn simultaneously via two battery handling system 10C.

Drone 100 communicates to microprocessor or controller 40 of package handling system 10 that battery feed tape 12 and delivered battery Bn is secure in drone battery feed tape capture system 240. Microprocessor or controller 40 initiates tape cutter 50 to cut, separate, release, or sever, for example, battery Bn from batteries Bn+1, Bn+2, on battery feed tape 12 and so on.

Drone 100 returns to service to transports package Pn to addressed delivery location via drone navigation algorithm, such as navigation to front door, garage (drone trigger garage to open & close), porch, drop box, or other designated delivery location and releases catch pin 145 to deposit package Pn. Drone 100 navigates and returns to drone platform 60 to pick up package Pn+1. Delivery truck T moves to next address location Pn+1. Repeat.

It is contemplated herein that battery handling system 10C may be independent of delivery truck T and be one or more standalone battery exchange station for one or more drones 100. Such system may be utilized in a factory, warehouse, shipping department, on a separate delivery truck T, spaced apart stations in specified areas (city) or campus, farm, ranch, business, or the like.

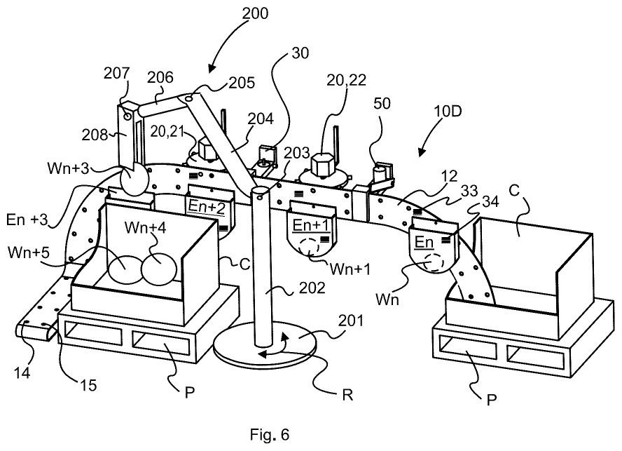

Referring now to FIG. 6, there is illustrated a preferred embodiment of envelope handling system 10C having one or more envelopes E or one set of delivery envelopes E such as delivery envelopes En, En+1, En+2, En+3, and so on affixed or removeably affixed in series to envelope feed tape 12 for transport to individual addresses or delivery stops DS of delivery route DR of delivery truck T. Each envelop E may contain an address or a machine readable code 34, such as bar code or RFID tag that can be scanned by code reader, such as package reader 30 and transmitted to microprocessor or controller 40 to control loading of widgets W into envelope E to become packages Pn. It is contemplated herein that addressed envelope E, of one or more envelopes E or one set of delivery envelopes E such as delivery envelopes En, En+1, En+2, En+3, and so on, may include an address or machine readable code 34 associated with a delivery address in a sequence of delivery stops DS of delivery route DR of delivery truck T(delivery stop sequence).

Envelope handling system 10C may include drones 100 or robotic devices, such as robotic arm 200 having base 201, vertical extension arm 203 to raise and lower gripper hand 208 as well as rotate gripper hand 208 about rotation R, one or more extension arms, such as first extension arm 204 pivotably connected to vertical extension arm 202, and second extension arm 206 pivotably connected to first extension arm 204 to enable precise positioning of gripper hand 208, and gripper hand 208 rotationally connected to second extension arm 206 to enable identification, such as (selecting a product, such as widget Wn ordered by a customer with address or machine readable code 34 associated with a delivery address in a sequence of delivery stops DS of delivery route DR of delivery truck T) and picking of designated widget(s) Wn from container C (on a palate) or conveyor belt and placing designated widget(s) Wn in envelope En as feed tape 12 traverses its course to form package(s) Pn.

Delivery stops Dn corresponds to envelope En having therein widget Wn to form package Pn positioned on feed tape 12 for delivery in sequence to address An corresponding to delivery stops DS of delivery route DR of delivery truck T.

It is contemplated herein that robotic arm may be a drone, robot, or like unmanned widget Wn picker.

Envelope handling system 10C may utilize robotic arm 200 to pick designated widget Wn associated with delivery address in a sequence of delivery stops DS of delivery route DR of delivery truck T and place designated widget Wn in envelope En of one or more envelopes En, En+1, En+2, En+3, and so on to form delivery package Pn in a sequence of delivery packages Pn, Pn+1, Pn+2, Pn+3, Pn+4, Pn+5, Pn+6, Pn+7 affixed to tape feed 12 according to a sequence of delivery stops DS of delivery route DR of delivery truck T (delivery stop sequence). Next, feed tape mechanism 20 propels feed tape 12 and one or more envelopes En to position next envelope En+1 from one or more envelopes En+1, En+2, En+3 and so on proximate or close in distance robotic arm 200. Robotic arm 200 picks next designated widget Wn+1 associated with a next delivery address in a sequence of delivery stops DS of delivery route DR of delivery truck T and places next designated widget Wn+1 in an envelope En+1 from one or more envelopes En+1, En+2, En+3 and so on to form a next delivery package Pn+1 in a sequence of delivery packages Pn, Pn+1, Pn+2, Pn+3, Pn+4, Pn+5, Pn+6, Pn+7 and so on. Repeat to form in sequence delivery packages Pn, Pn+1, Pn+2, Pn+3, Pn+4, Pn+5, Pn+6, Pn+7 associated with a series of delivery address in a sequence of delivery stops DS of delivery route DR of delivery truck T (delivery stop sequence).

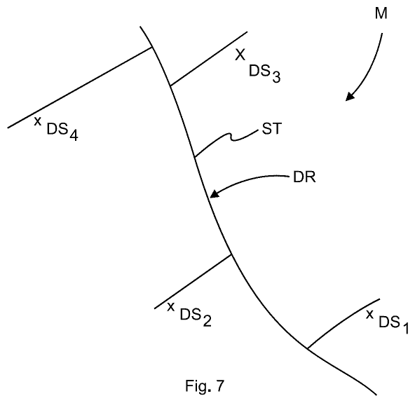

Referring now to FIG. 7, there is illustrated a preferred embodiment of a map M of a delivery route DR having a series of delivery stops DSn (DS1) for delivery of package Pn containing widget Wn, DSn+1 (DS2) for delivery of package Pn+1 containing widget Wn+1, DSn+2 (DS3) for delivery of package Pn+2 containing widget Wn+2, DSn+3(DS4) for delivery of package Pn+3 containing widget Wn+3 (addresses) associated with designated delivery packages Pn, Pn+1, Pn+2, Pn+3, having delivery contents, such as widgets Wn, Wn+1, Wn+2, Wn+3, ordered by customers Cn, Cn+1, Cn+2, and Cn+3 associated with the series of delivery stops DS of delivery route DR of delivery truck T.

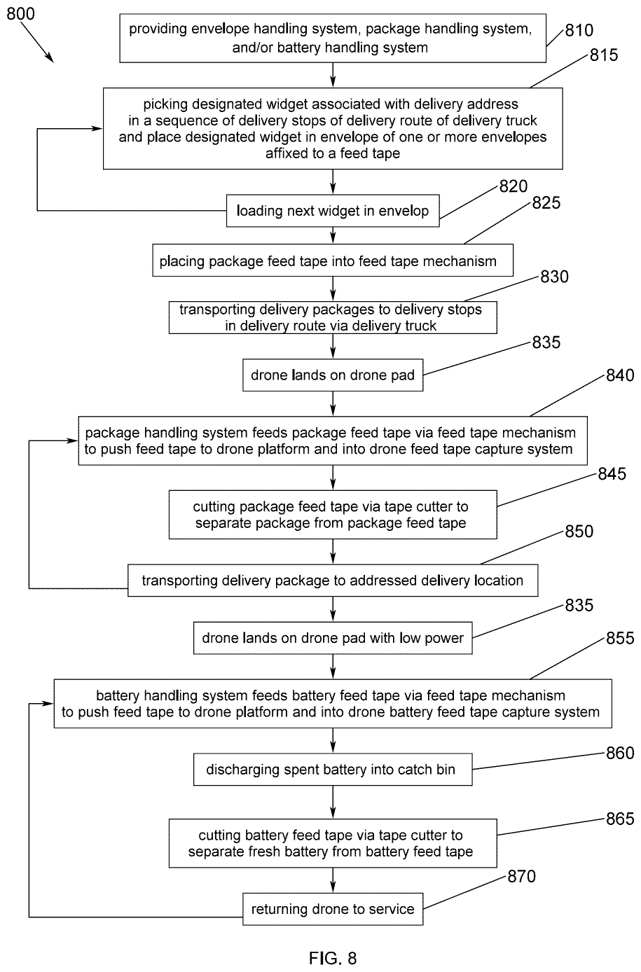

Referring now to FIG. 8, there is illustrated a flow diagram 800 of a method of operation and use of envelope handling system 10D, package handling system 10, package handling system 10B, and/or battery handling system 10C. In block or step 810, providing envelope handling system 10D, package handling system 10, package handling system 10B, and/or battery handling system 10C as described above in FIGS. 1-7. In block or step 815, utilizing robotic arm 200 to pick(ing) designated widget Wn associated with delivery address in a sequence of delivery stops DS of delivery route DR of delivery truck T and place designated widget Wn in envelope En of one or more envelopes En, En+1, En+2, En+3, and so on to form delivery package Pn in a sequence of delivery packages Pn, Pn+1, Pn+2, Pn+3, Pn+4, Pn+5, Pn+6, Pn+7 affixed to package tape feed 12 according to a sequence of delivery stops DS of delivery route DR of delivery truck T. In block or step 820, loading next widget Wn+1 in envelope En+1 and repeat until delivery packages Pn, Pn+1, Pn+2, Pn+3, Pn+4, Pn+5, Pn+6, Pn+7 have been filled (delivery stop sequence).

In block or step 825, placing package feed tape 12 into feed tape mechanism 20, 21, 22 and configured to drive, push and pull, or move (to propel) package feed tape 12 in preferably linear motion toward drone platform 60.

In block or step 830, transporting delivery packages Pn, Pn+1, Pn+2, Pn+3, Pn+4, Pn+5, Pn+6, Pn+7 to delivery stops DS in delivery route DR of delivery truck T, such as delivery stops DSn (DS1) for delivery of package Pn containing widget Wn.

In block or step 835, landing drone 100 on drone platform 60.

In block or step 840, picking delivery packages Pn via package handling system 10 feeds or moves package feed tape 12 through feed tape mechanism 20 and feed tape mechanism 20 moves or pushes or pulls package feed tape 12 to drone platform 60 and preferably between pair of spaced apart landing pads 61, 62 into drone feed tape capture system 140. Where drone feed tape capture system 140 grips or slides catch pin 145 in to feed tape apertures 14 of package feed tape 12 to secure package Pn to drone feed tape capture system 140 of drone 100.

In block or step 845, cutting package feed tape 12 via tape cutter 50 to cut, separate, or sever, for example, delivery package Pn from Pn+1, Pn+2, Pn+3, Pn+4, Pn+5, Pn+6, Pn+7 and so on.

In block or step 850, transporting delivery package Pn to addressed delivery location, delivery stops DS of delivery route DR from delivery truck T via drone 100 carrying delivery package Pn to addressed delivery location, delivery stops DS of delivery route DR from delivery truck T. Repeat for Pn+1, Pn+2, Pn+3, Pn+4, Pn+5, Pn+6, Pn+7 and so on (delivery stop sequence).

In block or step 835, landing drone 100 on drone platform 60.

In block or step 855, loading fresh battery into drone 100 via battery handling system 10C feeds, pushes or pulls, or moves battery feed tape 12 through feed tape mechanism 20 and feed tape mechanism 20 moves or pushes or pulls battery feed tape 12 to drone platform 60 and preferably into or through drone battery feed tape capture system 240.

In block or step 860, discharging spent battery into catch bin via spent battery Bn−1 is pushed from at least one battery receiver, drone battery feed tape capture system 240, or such as spaced apart first battery receiver 241 and second battery receiver 242 and drops spent battery Bn−1 into catch bin 70 positioned below drone platform 60.

In block or step 865, cutting battery feed tape 12 via tape cutter 50 to cut, separate, release, or sever, for example Bn from Bn+1, Bn+2 and so on. Repeat for Bn+1, Bn+2 and so on.

Concerning the description herein, it is to be realized that the optimum dimensional relationships, including variations in size, materials, shape, form, configuration, position, connection, function and manner of operation, assembly and use, are intended to be encompassed by the present disclosure.

It is further understood herein that the parts and elements of this disclosure may be located or positioned elsewhere based on one of ordinary skill in the art without deviating from the present disclosure.

The foregoing description and drawings comprise illustrative embodiments. Regarding the described exemplary embodiments, it should be noted by those skilled in the art that the disclosures within are exemplary only, and that various other alternatives, adaptations, and modifications may be made within the scope of the present disclosure. Merely listing or numbering the steps of a method in a particular order does not constitute any limitation on the order of the steps of that method. Many modifications and other embodiments will come to mind for one skilled in the art this disclosure pertains to, having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. A package handling system for transferring delivery packages from a delivery vehicle to
a drone, the drone then traverses to a designated delivery stop, the system comprising:
a delivery truck having a cargo area;
a robotic arm mounted inside said cargo area and configured to reach therearound said cargo area; and
a drone platform attached to said delivery truck, wherein said robotic arm is configured to pick the delivery package from said cargo area and place the delivery package onto said drone platform.

2. The package handling system of claim 1, wherein said drone platform is hingedly configured to pivot between a stowed position and a horizontal operating position.

3. The package handling system of claim 2, further comprising a controller in communication with said robotic arm and said drone platform, said controller configured to synchronize movement of said robotic arm with said pivoting of the drone platform.

4. The package handling system of claim 1, wherein said robotic arm having an end effector configured to grasp said delivery package.

5. The package handling system of claim 1, further comprising a storage bin removeably positioned within said cargo area and containing the delivery packages.

6. The package handling system of claim 1, wherein said drone platform is mounted to a rear of said delivery truck.

7. The package handling system of claim 1, further comprising a drone having a capture mechanism configured to engage the delivery package on the drone platform after placement by said robotic arm and thereafter said drone traverse to the designated delivery stop.

8. The package handling system of claim 1, wherein the delivery packages are pre-sequenced in said cargo area according to a delivery route.

9. A package handling system for direct handoff of a delivery package from a robotic arm to
a drone, the drone then travers to a designated delivery stop, the system comprising:
a delivery truck having a cargo area;
a robotic arm mounted inside said cargo area and configured to reach therearound said cargo area; and
a drone having a capture mechanism, wherein said robotic arm is configured to pick the delivery package from said cargo area and extend the delivery package into open air adjacent to the truck, and said drone hovers adjacent to said robotic arm such that said capture mechanism receives the delivery package directly from an end effector of said robotic arm, and said drone traverses thereafter to the designated delivery stop.

10. The package handling system of claim 9, wherein said end effector is configured to handoff the delivery package to said capture mechanism of said drone.

11. The package handling system of claim 9, further comprising a controller configured to coordinate timing between said robotic arm, said end effector, and said drone in hover position.

12. The package handling system of claim 9, further comprising a storage bin removeably positioned within said cargo area and containing the delivery packages.

13. The package handling system of claim 11, wherein the robotic arm is configured to retract into the cargo area after the handoff is complete.

14. The package handling system of claim 9, wherein the delivery packages are pre-sequenced in said cargo area according to a delivery route.

15. A package handling system for transferring delivery packages from a delivery vehicle to a rover, the rover then traverses to a designated delivery stop, the system comprising:
a delivery truck having a cargo area;
a robotic arm mounted inside said cargo area and configured to reach therearound said cargo area; and
a ground rover having a platform, wherein the robotic arm is configured to pick a delivery package from said cargo area and place the delivery package onto the platform of said rover for delivery of the package to the designated delivery stop.

16. The package handling system of claim 15, wherein said rover comprises a chassis, suspension posts supporting said platform, four wheels, drive mechanism, power supply, and controller.

17. The package handling system of claim 15, wherein said robotic arm having an end effector configured to grasp the delivery package.

18. The package handling system of claim 15, further comprising a controller configured to coordinate timing between said robotic arm, said end effector, and said rover.

19. The package handling system of claim 15, further comprising a storage bin removeably positioned within said cargo area and containing the delivery packages.

20. The package handling system of claim 15, wherein the delivery packages are pre-sequenced in said cargo area according to a delivery route.

21. The package handling system of claim 15, further comprising a controller configured to synchronize said robotic arm movement with a position of said rover on the ground.

22. The package handling system of claim 16, wherein said chassis further comprising a forklift mechanism for retrieval of a palleted package.
